(19) United States
(12) Patent Application Publication
(10) Pub. No.: US 2005/0193106 A1
(43) Pub. Date: Sep. 1, 2005

(54) Service discovery and delivery for ad-hoc networks

(75) Inventors: Nitin Desai, Coconut Creek, FL (US); Abdelsalam Helal, Gainesville, FL (US); Varun Verma, Coconut Creek, FL (US)

Correspondence Address: AKERMAN SENTERFITT, P.O. BOX 3188, WEST PALM BEACH, FL, 33402-3188, US

(73) Assignee: University of Florida, Gainesville, FL (US)

(21) Appl. No.: 10/790,371

(22) Filed: Mar. 1, 2004

(51) Int. Cl. G06F 15/16; G06F 15/173

(52) U.S. Cl. 709/223; 709/230

(57) ABSTRACT

The present invention can include a communication system having a plurality of portable devices being communicatively linked via an ad-hoc, wireless network such that each portable device functions in a peer-to-peer fashion. Each portable device can include a communication architecture including an application configured to control service discovery, usage, and advertising, a service manager and a micro-hypertext transfer protocol server. The service manager can be configured to discover services provided by other ones of the portable devices, and register and advertise services provided by the portable device within which the service manager is disposed, under control of the application. The micro-hypertext transfer protocol server can be configured to send and receive queries to facilitate service discovery, usage, and advertising.

### BACKGROUND

1. Field of the Invention

The present invention relates to the field of communications and, more particularly, to service discovery and delivery over ad-hoc networks.

2. Description of the Related Art

The use of mobile devices such as laptop computers, cell phones, and personal data assistants has continued to increase over the last several years. The popularity of such devices has been matched by the proliferation of wireless technologies such as 802.11, Blue Tooth, and the like. In consequence, wireless networks are fast becoming as common as more traditional wired communication networks.

The emergence of wireless technology has led to the development of ad-hoc networks. Ad-hoc networks are characterized by a lack of required infrastructure and the ease with which such networks can be formed. Each device participating in an ad-hoc, wireless network is mobile. In consequence, ad-hoc networks are formed temporarily as the member devices can continually change.

Existing service discovery protocols and delivery mechanisms are unable to accommodate the complexities of an ad-hoc network environment. Further, conventional discovery and delivery mechanisms emphasize hardware device capabilities as services rather than software services. This renders such mechanisms unsuitable for mobile applications.

What is needed is a device independent architecture that can facilitate service discovery and delivery within an ad-hoc, peer-to-peer, wireless network.

### SUMMARY OF THE INVENTION

The present invention provides a method, system, and apparatus for service discovery and delivery for use with ad-hoc, peer-to-peer, wireless networks. The inventive arrangements disclosed herein provide an architecture that allows devices within the network to query other devices to determine services available within the network, advertise available services to other devices in the network, as well as provide or obtain those services.

One embodiment of the present invention can include a communication system having a plurality of portable devices being communicatively linked via an ad-hoc, wireless network such that each portable device functions in a peer-to-peer fashion. Each portable device can include a communication architecture including an application configured to control service discovery, usage, and advertising, a service manager and a micro-hypertext transfer protocol server. The service manager can be configured to discover services provided by other ones of the portable devices, and register and advertise services provided by the portable device within which the service manager is disposed, under control of the application. The micro-Hypertext Transfer Protocol server can be configured to send and receive queries to facilitate service discovery, usage, and advertising.

Another embodiment of the present invention can include a method of providing services over an ad-hoc, peer-to-peer, wireless network. The method can include, within a portable device, transmitting a service discovery message to a fixed multicast group over the network, receiving a service advertising message from at least one other portable device of the fixed multicast group, and matching a service specified by the service advertising message with a location within a service registry of the portable device. The matched service can be incorporated within the service registry, wherein the matched service specifies a network address for retrieving information about the matched service.

Another embodiment of the present invention can include a method of providing services over an ad-hoc, peer-to-peer, wireless network. The method can include, within a first server device, receiving a service discovery message over the network from a client device, wherein the service discovery message requests a service, and generating a response to the service discovery message, wherein the response specifies differences between the requested service and a service registry of the first server device. The method also can include receiving a response to the service discovery message from a second server device, comparing the response from the second server device with the response of the first server device, and selectively sending the response of the first server device according to the comparing step.

Other embodiments of the present invention can include a machine readable storage, having stored thereon a computer program having a plurality of code sections executable by a portable computing device for causing the device to perform the various steps disclosed herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating an ad-hoc, peer-to-peer network in accordance with one embodiment of the present invention.

FIG. 2 is a schematic diagram illustrating an architecture of a wireless device for use in the network of FIG. 1 in accordance with one embodiment of the present invention.

FIG. 3 is a schematic diagram illustrating a service registry for use with the architecture of FIG. 2 in accordance with another embodiment of the present invention.

FIG. 4 is a schematic diagram illustrating a data structure of a service discovery message in accordance with one embodiment of the present invention.

FIG. 5 is a schematic diagram illustrating a data structure of a service advertisement message in accordance with one embodiment of the present invention.

FIG. 6 is an illustration of a service description language that can be used in accordance with the inventive arrangements disclosed herein.

FIG. 7 is a schematic diagram illustrating a service delivery architecture for delivering services between a server device and a client device in accordance with one embodiment of the present invention.

FIG. 8 illustrates a service delivery request in accordance with one embodiment of the present invention.

FIG. 9 is a schematic diagram illustrating a graphical user interface (GUI) for use with one embodiment of the present invention.

FIG. 10 is a schematic diagram illustrating a GUI for use with another embodiment of the present invention.

FIG. 11 is a flow chart illustrating a method of operation in accordance with another embodiment of the present invention.

FIG. 12 is a flow chart illustrating a method of operation in accordance with yet another embodiment of the present invention.

### DETAILED DESCRIPTION OF THE INVENTION

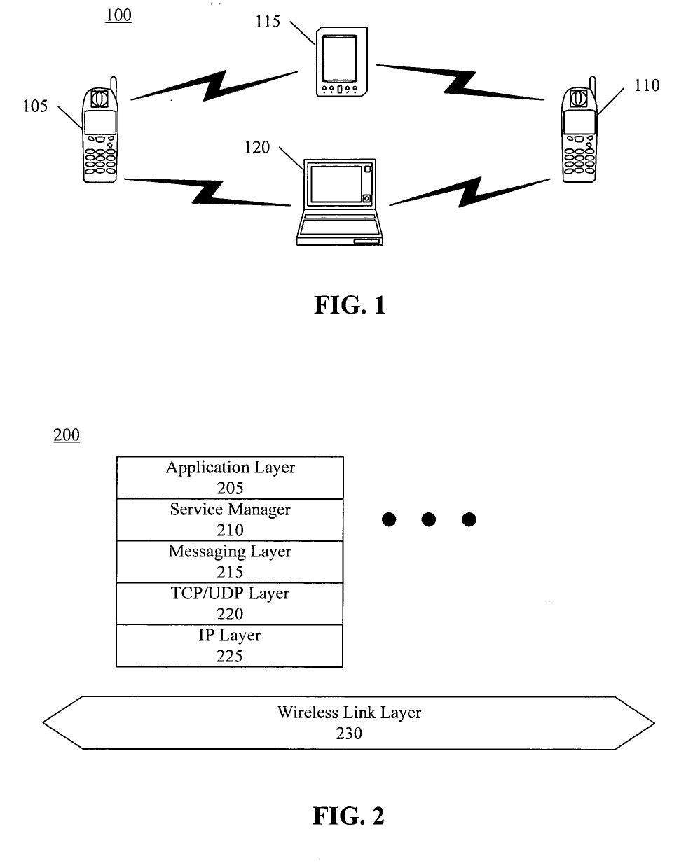

FIG. 1 is a schematic diagram illustrating a wireless, ad-hoc, peer-to-peer network 100 in accordance with one embodiment of the present invention. As shown, the network 100 can include a plurality of portable communication devices, each capable of two-way wireless communications with other devices belonging to network 100. For example, the network 100 can include one or more mobile telephones 105 and 110, a personal digital assistant 115, and a portable or laptop computer 120.

It should be appreciated that any suitable communication device can be joined to the network 100 and that the devices illustrated in FIG. 1 are shown for purposes of illustration only. As such, the specific devices shown are not intended as a limitation of the present invention. For example, in one embodiment, the participating devices can be limited to devices capable of mobile communication.

The network 100 can be implemented as a local area network or other small network. As such, in accordance with the embodiments to be described herein, the network 100 can utilize any of a variety of communication protocols. For example, the devices 105-120, having or being connected to suitable wireless transceivers, can communicate with one another via one of the 802.11 family of wireless communications protocols, Bluetooth, or the like.

The network 100 is an ad-hoc network in that temporary connections are supported in which one or more of the devices 105-120 are part of the network 100 for the duration of a communication session, or in the case of a mobile or portable device, when in close proximity with the network 100. The network 100 is peer-to-peer in that the network 100 embraces a communications model in which each participant device 105-120 in network 100 has the same capabilities as the other participant devices and can initiate a communication session. For example, in one embodiment of the present invention, peer-to-peer communications can be implemented by providing each communication node or device with both server and client capabilities.

Each device 105-120 shown in FIG. 1 can be configured to, in the absence of administrative services, obtain IP addresses automatically. Many modem operating systems support such a feature. If the network 100 is comprised of multiple overlapping radio cells, each device or node can be assumed to have a routing capability to form a wider ad-hoc network. Each device 105-120 can join a locally scoped multi-cast group, a multicast address out of a link-local range 239.255.0.0/16 to facilitate peer-to-peer networking among the devices.

FIG. 2 is a schematic diagram illustrating an architecture 200 of a wireless device for use in the network of FIG. 1 in accordance with one embodiment of the present invention. As shown, the architecture 200 can include an application layer 205, a service manager 210, a messaging layer 215, a transmission control protocol (TCP)/universal datagram (UDP) layer 220, and an Internet Protocol (IP) layer 225. A device having an architecture 200 can communicate with other devices so configured over a wireless link layer 230. The architecture 200 disclosed herein permits a wireless device to host local services, deliver its own services using a resident Hypertext-Transfer Protocol (HTTP) server, query the network for available services offered by other devices, and use discovered services in the network.

The application layer 205 can include one or more applications that facilitate human interaction to initiate and control advertising of services to other devices within the network, discovery of services offered by other devices within the network, and service usage on behalf of the device within which the application executes. The service manager 210 can be controlled by the applications residing in the application layer 205.

The service manager 210 can discover, from the network, any services required by applications in the application layer 205. The service manager 210, as shown, operates above the messaging layer 215 to send and receive discovery and advertisement messages to and from the network. In addition, the service manager 210 can administer the service registry stored therein, and to be described in further detail. For example, the service manager 210 can add entries, remove entries, such as expired services, and perform comparisons of received messages with the service registry disposed therein.

The messaging layer 215 rests above the TCP/UDP layer 220. The messaging layer 220 sends and receives advertisement and discovery messages. As devices using the architecture 200 can function as both client and server, the messaging layer 215 can provide different functions depending upon the role assumed by the device.

For a device functioning as a client, the messaging layer 220 handles, or receives, advertising messages sent by one or more other server devices. In that case, the messaging layer 220 aids in service discovery by sending out client discovery messages. For a device functioning as a server, the messaging layer 220 handles, or sends, service advertising messages. The messaging layer 220 further can respond to client discovery messages. That is, the messaging layer 220 can receive client discovery messages and respond back to the source with a service advertising message.

The TCP/UDP layer 220 provides support for communicating over the wireless network. The TCP/UDP layer 220 packetizes data into one or more datagrams for transmission and interprets received packets of information. As indicated, this layer provides support for both TCP as well as UDP-based communications. Notably, as UDP does not support sequencing of the order in which packets arrive, an application receiving information in the application layer 205 must ensure that the entire message has arrived as well as the ordering of the packets.

The Internet Protocol (IP) layer 225 delivers, sends and receives, data over the wireless link layer 230. As noted, the wireless link layer 230 can include, but is not limited to, one of the 802.11 family of wireless communication protocols, Bluetooth, or the like.

Using the architecture 200 disclosed herein, one or more devices having suitable transceivers can communicate with one another. That is, each device is capable of providing services to other devices and discovering and using services from other devices.

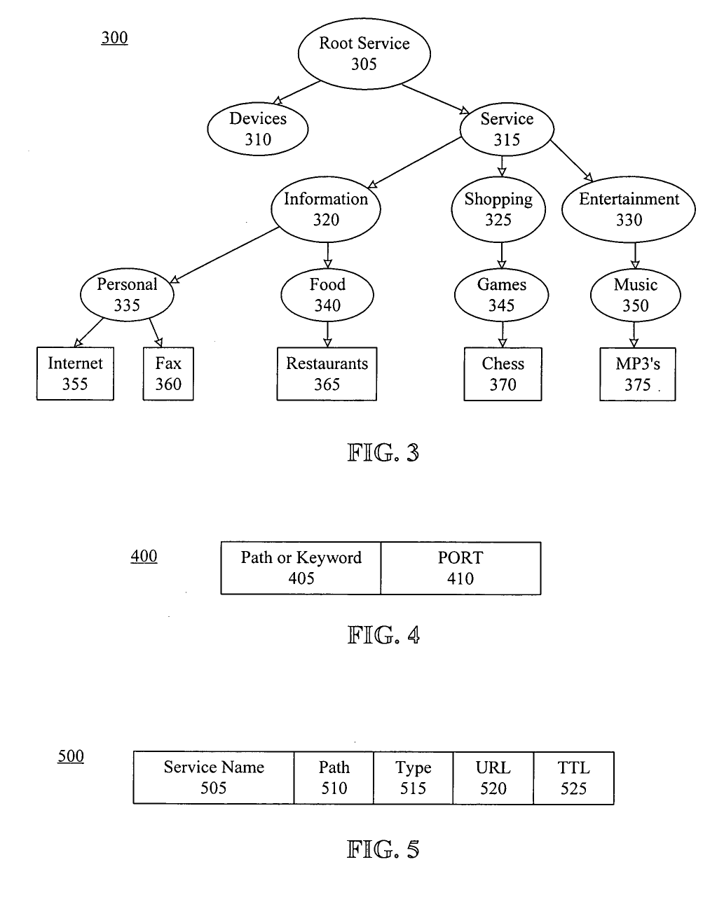

FIG. 3 is a schematic diagram illustrating a service registry 300 disposed within, and administered by, a service manager according to one embodiment of the present invention. As shown, the service registry 300 specifies a hierarchy of services that are available from the portable computing device within which that service registry 300 is disposed. The service registry 300 also specifies services, within the hierarchy, that have been discovered by the portable device within which the service registry is stored. For example, a device can receive an advertisement from another device describing a service available from the sending device and store that information within the service registry 300.

The service registry 300 can include a number of levels that represent service classifications arranged in tree-like fashion. Moving from the root node 305 to the leaves 355, 360, 365, 370, and 375 of the tree, services become more specific. The oval shaped nodes, nodes 310, 315, 320, 325, 330, 335, 340, 345, and 350, represent generic service types that form a basic service tree. Services shown in rectangles 355, 360, 365, 370, and 375, the leaves, are actual services and can be added under any generic service or oval shaped node based on the classification type of the service.

Actual services 355, 360, 365, 370, and 375 can be either offered by the device itself or from other devices in the network. As such, the node can indicate whether the service is available from that device or another, as well as any necessary network addresses for the offering server device. Services can be classified as “all”, “generic”, or “specific” based on the tree level. As an example, selecting the root node 305 indicates all services in the service registry 300. Selecting nodes at intermediate levels of the tree, i.e. node 315 or 320, indicates generic services. Selection of such an intermediate node specifies all actual services that are present below the identified node, following the appropriate branches to the leaves of the tree. Thus, selecting node 315 can indicate services 355, 360, 365, 370, and 375, while selecting node 320 indicates services 355, 360, and 365. Actual services can be referred to with specificity by identifying the particular leaf node of the service registry 300 corresponding to the desired service.

The service registry 300 is useful to devices when acting as client or server. The service registry 300 can be used by a device functioning as a server to register local services that it wishes to offer, to advertise the registered services at any level, i.e., “all”, “generic”, or “specific”, and to respond to client discovery requests. Devices functioning as clients can use the service registry discover “all”, “generic”, or “specific” services, and manage those services.

Inclusive or exclusive filtering options can be employed at different levels of interest for client devices. Exclusive filters, which can be set at any level of the service registry 300, allow a client device to specify whether services advertised under a particular category of the service registry 300 will be received. The category can be determined with reference to the path through the service registry 300. Exclusive filters can aid in counteracting outbursts of service advertisement messages from server devices. Inclusive filters, which also can be set at any level of the service registry 300, allow the client device to receive notification if one or more services within, or beneath, a particular category or node become available. Device capabilities, like memory size, also can be used as a parameter to set filters to add any discovered or advertised service into the service registry 300.

Each service 355-375 can be associated with a lease time, that is, the time for which the service is expected to remain available. This time is specified as the time-to-live (TTL) of the service, which is part of service registration or advertisement information sent by a server device. The service provider, or server device, decides what the TTL value will be for each service offered by the server device. Services must be refreshed before the TTL for that service expires. That is, a server device must update the TTL value of a service within the service registry prior to, or just after the TTL value expires so that the service can be made available to other client devices. Otherwise, a service with an expired TTL is removed from the service registry 300.

Devices functioning as clients can discover services on the network through an active pull mechanism. Active pull mechanisms require the device in need of a service to request that service from participating devices in the network. Devices functioning as servers also can utilize a passive push mechanism to advertise services offered by those devices. The present invention supports both push and pull mechanisms such that devices functioning as clients or servers can discover and advertise services on a need basis.

FIG. 4 is a schematic diagram illustrating a data structure of a service discovery message 400 in accordance with one embodiment of the present invention. As shown, the discovery message 400 can include a path or keyword portion 405 and a port number 410. A path can be specified when the client desires “all” services in the network or services defined by some “generic” service type. That is, the requesting client can select all services beneath a particular node as specified by a path through the service registry. For the discovery of a particular service, i.e. a “specific” service, a keyword can be specified. The port number 410 of the message specifies the port over which the client listens for server replies by unicast.

The service discovery process can include two steps. First, a client device can send a discovery message on a fixed multicast group. Next, all the server devices that have the service being sought by the client device can respond.

Upon receiving a discovery message sent out on a fixed multicast group by a client device, each server device can perform service matching. If the matching operation is a path-based discovery, the server device matches the path specified by the service discovery message 400 with its registry tree and obtains all the registered services under the node indicated by the path. If the discovery request is based on a keyword, the server device matches the keyword with each local service's keywords as the keywords are an element of each service description within the service registry.

FIG. 5 is a schematic diagram illustrating a data structure of a service advertisement message 500 in accordance with one embodiment of the present invention. If a server device finds a match, the server device creates a service advertisement message 500 for each match found. The service advertisement message 500 can include the actual service name 505, the path 510 to the service through the service registry of the server device, the type 515 of the service, the URL or other address 520 where the service description will be available, and a time-to-live 525 parameter of the service, which can be specified in a unit of time such as minutes or seconds.

Similar to the discovery process, service advertisement messages 500 can also be based on “all”, “generic”, or “specific” services. The server device can advertise “all” services registered within the device, “generic” services identified by some path in the service registry, or a specific service defined by one or more particular leaf nodes. Upon receiving a service advertisement message 500 or messages, the client device identifies the path specified in the service advertisement message 500 and matches it with the service registry disposed within the client device. While doing so, if the client device finds that there is an exclusive filter on any of the nodes of the path, the service is discarded. If not, the service is added under the path 510 specified in the service advertisement message 500. If the path 510 has an inclusive filter set, the client device can notify a user of the client device of this new service.

Service delivery can include a service description process where a client device learns about the properties and capabilities of a service. The next phase of service delivery is service usage where the client device avails itself of a service.

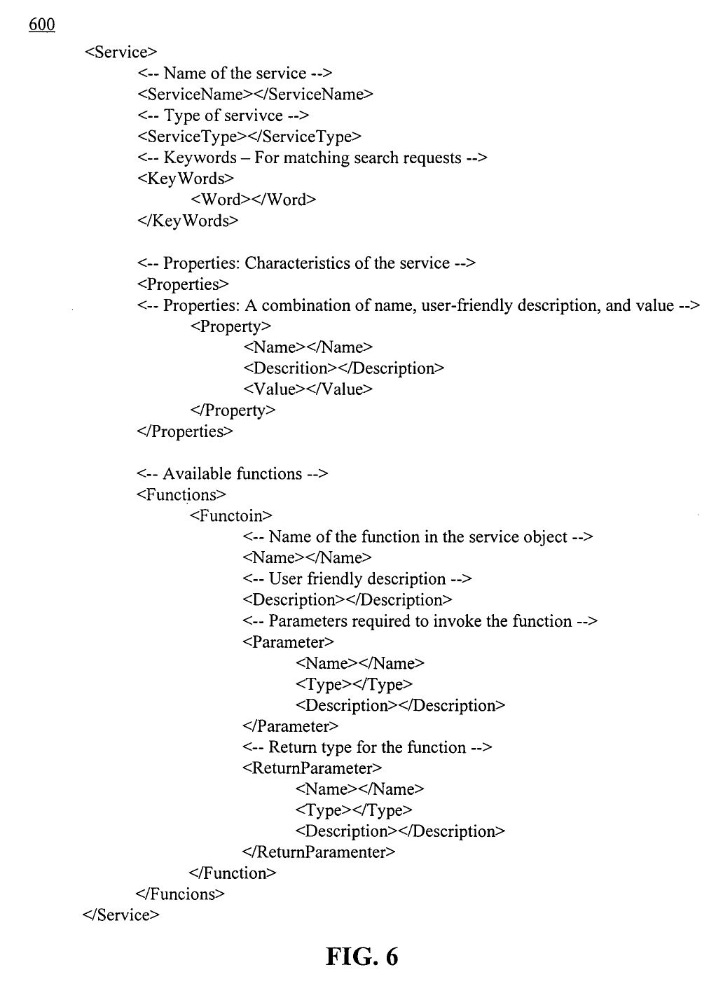

FIG. 6 is an illustration 600 of a service description language that can be used in accordance with the inventive arrangements disclosed herein. In accordance with one aspect of the present invention, each service can be implemented as a bundle of two components, a service description that describes a service and a service object. The service registry of any server device contains these two components for each service being offered by that device.

While the service object can be in the form of a class file, a Dynamic Linked Library (DLL), or the like, the service description can be implemented as a plain text file containing complete information about the characteristics and functions of the service. FIG. 6 illustrates tags of an XML-based service description language that allows a service to explain its characteristics, for example within a service description.

The root of the document is the “Service” tag. The “Service” tag represents the start of the service definition. The first child is “ServiceName”. “ServiceName” can be used to define a user-friendly name for the service. The next tag, “ServiceType”, can define the type of the service, e.g. printer or music. The service type along with the relevant path in the tree can be used to advertise the service. The third child is the “Keywords” tag. The “Keywords” tag can be used to specify keywords that describe the service type or one or more characteristics of the service. For example, for a service offering opportunities to print documents, the “ServiceType” tag can specify “print”, while the “Keywords” tag can specify “laser printers”, “color printers”, or “printing”.

While the first three children of the “Service” tag are primarily used in service discovery and advertisement, the “Properties” and “Functions” tags can be used in service description and delivery. The “Properties” tag can be used to specify the characteristics of the service. Each service can have any number of properties. Each property can be a combination of a name, a description, and a value.

The “Name” tag of the property can be used to specify a service name for purposes of communication between the server device and the client device. Using this name, the client application may be allowed to subscribe to events related to this property, e.g., the client may be interested in being informed when the property changes to a particular value. The “Description” tag can be used to specify a user-friendly explanation of the property. The “Value” gives the current value of the property.

The functions specified by the “Function” tag are related to the actual invocation of the service. A service can have any number of functions. Each function can be a combination of a name, a description, one or more parameters, and a return parameter. The “Name” tag within the function description can be used to specify the name given to the actual method in the service object. The “Description” tag can be used to provide an explanation to a user as to what action the function provides. The “Parameter” tag can be used to specify arguments needed to invoke a function. Similar to properties, parameters also can include a name, a description and a type. While the “Name” tag can specify a name for communication between server device and client device, the “Description” tag can be used to instruct a user as to what information is required to invoke a function. The “Type” tag can specify the data type for the argument, e.g., type could be string, integer, or file.

A client application can use the type information to enforce the validity of user input. Each function also can include a “ReturnParameter” tag. The “ReturnParameter” tag is similar in structure to the “Parameter” tags. The “ReturnParameter” tag can be used to specify the information obtained on invoking the function.

While the markup language illustrated above is implemented as an XML-based language, it should be appreciated that any of a variety of data structures, languages, or the like can be used to specify such information. The arrangements disclosed herein, however, have been implemented with an awareness of the resource-poor mobile devices in which the information will likely be used.

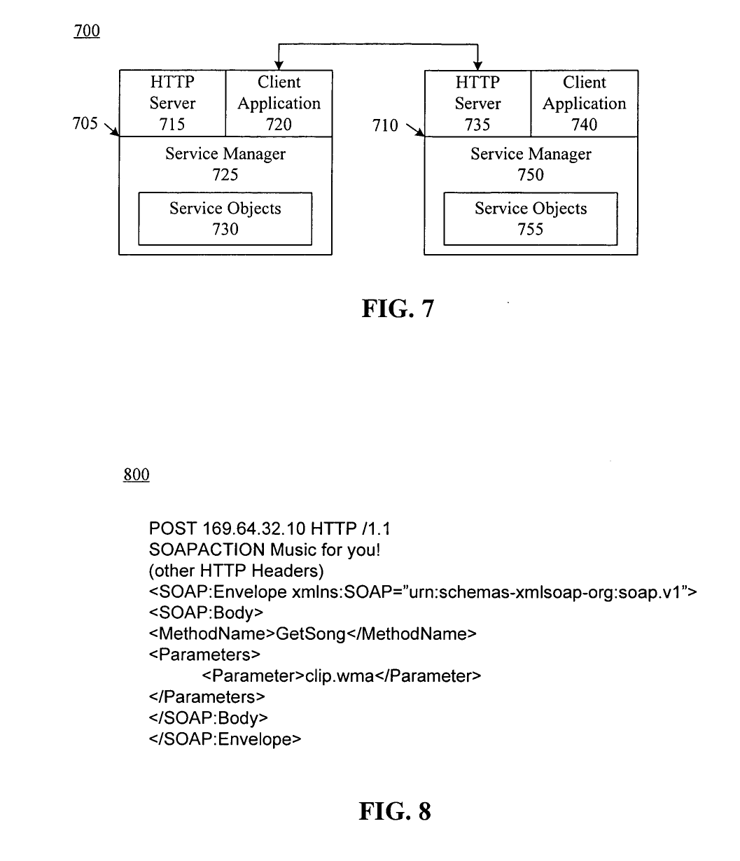

FIG. 7 is a schematic diagram illustrating a service delivery architecture 700 for delivering services between a server device and a client device in accordance with one embodiment of the present invention. As shown, the service architecture 700 includes a client architecture 705 and a server architecture 710. The client architecture includes a HTTP server 715, one or more client applications 720, a service manager 725, and one or more service components 730 disposed within the service manager 725. Similarly, the server architecture 710 can include a HTTP server 735, one or more client applications 740, a service manager 745, and one or more service components 750 disposed therein.

The HTTP servers 715 and 735 can be implemented as micro-HTTP servers. A micro-HTTP server can be defined as a light-weight HTTP server. A micro-HTTP server can functions as the primary component in the service delivery architecture. In accordance with one embodiment of the present invention, a micro-HTTP server can provide two varieties of requests—a service description and a function invocation. A micro-HTTP server can act as the main link between client applications, or services, and the underlying architecture.

The HTTP servers 715 and 735 can utilize worker threads to handle client requests. HTTP headers in requests can be used to determine the request type. In the case of service description requests, a micro-HTTP server can respond with the requested service description. As noted the service description can be encoded as a markup language document, for example using XML. In the case of a service delivery request, also known as a function invocation, a micro-HTTP server can access the service manager to retrieve a service object. The micro-HTTP server then can invoke a pre-defined entry point in the service object using information received with the request. Once the micro-HTTP server gets a response from the service object, the micro-HTTP server can send the response back to the client device.

As shown, a service within the server architecture 710, for example a service object 755, can be executed responsive to a service request from the client architecture 705. Accordingly, information such as any parameters that may be required can be exchanged between the client application 720 and the HTTP server 735 over the wireless link layer as well as any service results.

Once a service has been discovered by a client device, the client device has limited knowledge about the service. The client device knows the user-friendly name of the service, service type, IP address of the server device offering the service, and the duration of availability of the service. Based on this information, the user of the client device may seek to get more information of the service. This process, referred to as service description, can be a beginning step in the process of service delivery. The client device follows the URL or address obtained during the discovery phase for more details. The address can specify a retrievable file having a description of the discovered service.

The service description file contains complete information about the properties of the service and the methods provided by the service. A requesting user can interact with the service by invoking any of the available functions and providing proper parameters to those functions. The user function invocation can be packaged as a Simple Object Access Protocol (SOAP) request and sent to the HTTP server of a server device. FIG. 8 illustrates a service delivery request 800 in accordance with one embodiment of the present invention.

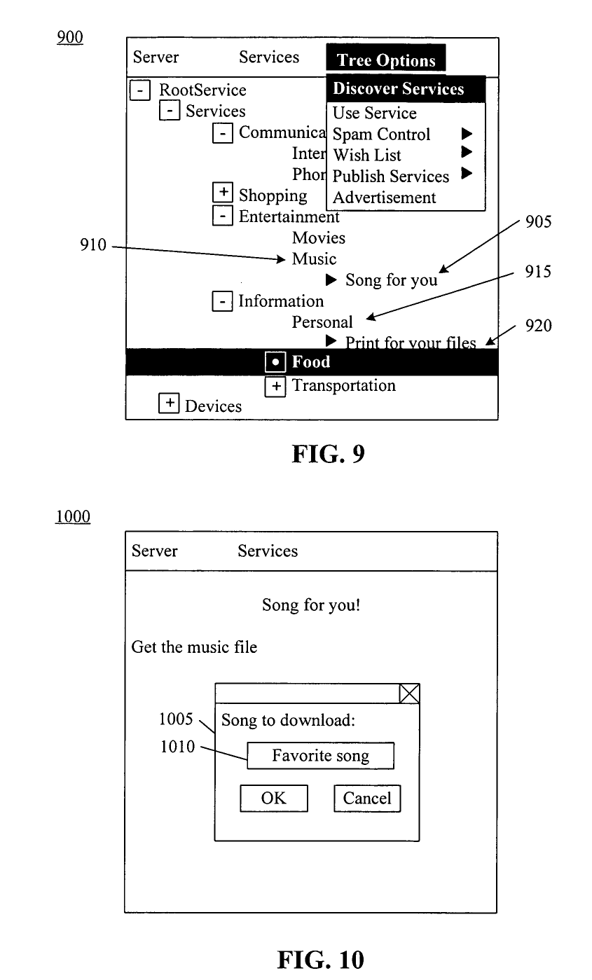

FIG. 9 is a schematic diagram illustrating a graphical user interface (GUI) 900 for use with a portable device according to one embodiment of the present invention. GUI 900 shows the registered service “Song for you!” 905 under “Music” 910 and the available service “Print your files” 915 under “Personal” 920. Responsive to a user input selecting “Tree Options” and “Discover Services”, the client device can send a service discovery message to other devices within the network to discover services relating to “Food” which is also selected as shown. The “Services” and “Tree Options” menus together provide functionalities such as discovery, advertisement, service registration, and exclusive/inclusive filter settings.

FIG. 10 is a schematic diagram illustrating a GUI 1000 for use with another embodiment of the present invention. GUI 1000 illustrates the result of an execution of the “Song for you!” service in the context of service delivery. As shown, a user can enter proper parameters for a function dialog box 1005 within a data entry field 1010 to retrieve the specified file from another device within the network that offers the specified service and having the specified file.

In accordance with the inventive arrangements disclosed herein, a set of Application Programming Interfaces (APIs) can be provided so that services can be built easily. The API set can include service advertisement and discovery, service description and invocation, service registry management, service lease management, as well as several utility and user interface APIs.

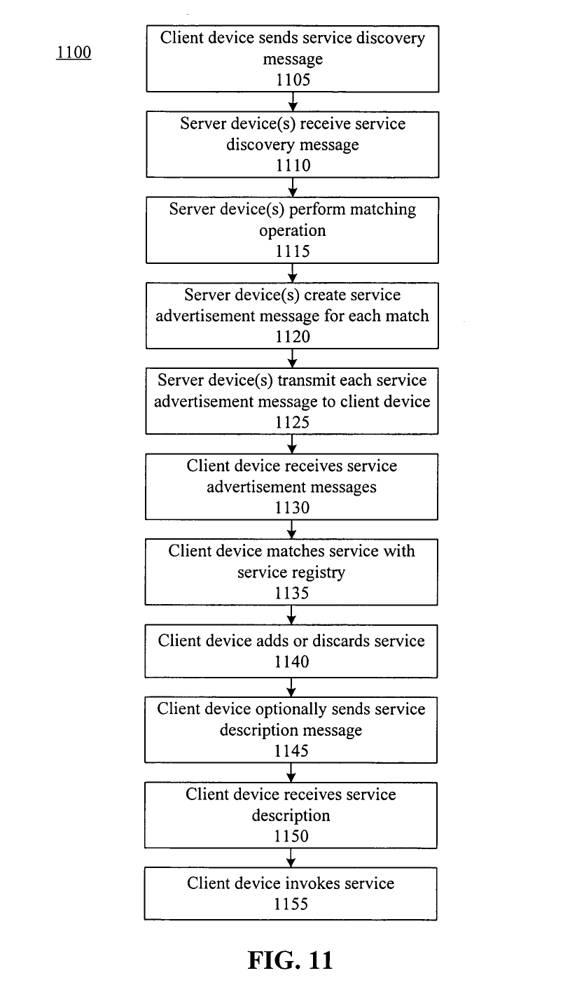

FIG. 11 is a flow chart illustrating a method 1100 of operation in accordance with another embodiment of the present invention. The method 1100 can begin in step 1105 where a client device sends a service discovery message to other devices within the ad-hoc, peer-to-peer, wireless network to determine the available services within the network, i.e. from the other devices. As noted, a service discovery message can be sent to a fixed multicast group. In step 1110, one or more server devices receive the service discovery message.

In step 1115, the server device(s) perform a matching operation. As noted, if the service discovery message specifies a path, then the specified path can be matched with the registry tree of the server device(s). If the discovery request specifies a keyword, then the service registry can be searched for a matching keyword. In step 1120, the server device(s) can create a service advertisement message for each match. Accordingly, any server device having received the service discovery message and having determined a match, can transmit a service advertisement message for each match of the path or keyword of the service discovery message with the service registry of the server device(s).

In step 1125, each server device can transmit one or more service advertisement messages to the port of the client device specified in the service discovery message. The client device can receive any transmitted service advertisement messages in step 1130. In step 1135, the client device can match received service information specified in service advertisement messages to the proper location within the service registry of the client device. The information can be added or discarded as appropriate in step 1140, for example depending upon whether the information is duplicative or the filtering that is applicable to that particular node or advertisement message.

In step 1145, the user of the client device optionally can send a service description message. The service description message can be sent in cases where additional information regarding a service is needed or desired. Notably, rather than sending a multicast message as in the case of the service discovery message, the service description message can be directed to the particular server device that offers the service for which additional information is needed. The server device can receive the service description message and respond. Accordingly, in step 1150, the server device receives the service description. In step 1155, the client device can invoke a service.

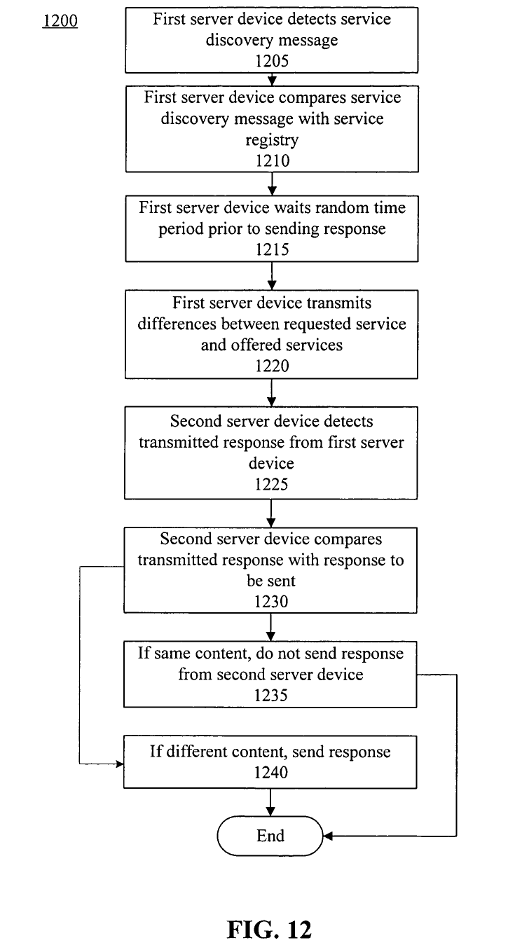

FIG. 12 is a flow chart illustrating a method 1200 of operation in accordance with another embodiment of the present invention. The method 1200 addresses an embodiment of the invention that reduces the amount of messages that are exchanged between client and server devices within the network when discovering services. The method can begin in a state where a client device has issued a service discovery message. Accordingly, one or more server devices within the network can receive or detect the service discovery message in step 1205. In step 1210, a first server device can compare the service discovery message with the service registry of the first server device. The first server device can determine whether a match exists for the service discovery message within its service registry. In step 1215, the first server device waits a random amount of time prior to sending a response. Though random, the time period can be predetermined.

In step 1220, after waiting the random amount of time, the first server device can send a response message describing the differences between the service discovery message and those services offered by the first server device. Accordingly, rather than sending an advertisement for each matching service, the first server device sends a message describing differences between the portion of the service registry of the server device and the services sought by the client device as specified in the service discovery message.

In step 1225, a second server device, one that has not already sent a response to the client device, can detect or receive responses from other server device(s) such as the first server device. In step 1230, the second server device can compare the received response with the response to be sent by the second server device to determine whether the content of the received response and the response to be sent is the same. If so, the method can proceed to step 1235. In step 1235, the response to be sent from the second server device can be canceled. If, however, the content of the responses is not the same, the second server device can send its response to the service discovery message in step 1240. The method 1200 can repeat as necessary for further server devices.

While the method 1200 has been described with reference to two server devices, those skilled in the art will appreciate that the methodology can be applied to larger networks having more than two server devices. Accordingly, each server device can await a random amount of time, specific to that server device, prior to responding. The server devices read responses from other server devices and only respond after the random time period expires, and if the server device provides a service pertinent to the service discovery message that has not been reported by another server device. The random waiting periods prevent each server device from responding at the same time and allows each server device to evaluate the content of responses from other servers before sending a response. This can prevent duplicative messages or responses from being sent by each server device in response to a service discovery message.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A communication system comprising a plurality of portable devices being communicatively linked via an ad-hoc wireless network such that each said portable device functions in a peer-to-peer fashion, wherein each said portable device includes a communication architecture comprising:
an application configured to control service discovery, usage, and advertising;
a service manager configured to discover services provided by other ones of said portable devices, and register and advertise services provided by said portable device within which said service manager is disposed, under control of said application; and
a micro-hypertext transfer protocol server configured to send and receive queries to facilitate service discovery, usage, and advertising.

2. The system of claim 1, said service manager having a service registry specifying a hierarchy of services available from the portable computing device within which said service manager is disposed, and specifying services, within said hierarchy, that have been discovered by said portable device.

3. The system of claim 2, wherein said portable device receives a service discovery message from a client device and a response from a server device, said portable device comparing the response from the server device with the service registry and responding to said service discovery message only if said service registry specifies different services than specified in the response from the server device.

4. The system of claim 2, said application comprising a user interface, wherein said hierarchy of services specified by said service registry correlates directly with said user interface.

5. The system of claim 1, wherein said service manager interacts with a messaging layer of said portable device, said messaging layer being in communication with a transport layer of said portable device.

6. The system of claim 1, wherein each service specified within said service registry has an expiration attribute, said service manager configured to purge said service registry of services that have expired.

7. The system of claim 1, wherein at least one of said plurality of portable devices is configured to transmit a service discovery message to a fixed multicast group.

8. The system of claim 7, wherein, upon receiving the service discovery message, at least one other of said plurality of portable devices locates a service matching said service discovery message and transmits a service advertisement message specifying one or more services matching said service discovery message.

9. The system of claim 1, wherein at least one of said portable devices includes a service, said service comprising:
a service object configured to perform said service and interact with said application disposed within another one of said plurality of portable devices having requested said service; and
a service description including information pertaining to properties of said service.

10. The system of claim 1, wherein said portable device waits a random time period prior to sending a response to a received service discovery request.

11. A method of providing services over an ad-hoc, peer-to-peer, wireless network comprising:
within a portable device, transmitting a service discovery message to a fixed multicast group over said network;
receiving a service advertising message from at least one other portable device of said fixed multicast group;
matching a service specified by the service advertising message with a location within a service registry of the portable device; and
incorporating the matched service within the service registry, wherein the matched service specifies a network address for retrieving information about the matched service.

12. The method of claim 11, further comprising:
transmitting a query to the network address of the matched service requesting additional information about the matched service;
receiving the additional information; and
invoking the matched service.

13. A method of providing services over an ad-hoc, peer-to-peer, wireless network comprising:
within a first server device, receiving a service discovery message over the network from a client device, wherein the service discovery message requests a service;
generating a response to the service discovery message, wherein the response specifies differences between the requested service and a service registry of the first server device;
receiving a response to the service discovery message from a second server device;
comparing the response from the second server device with the response of the first server device; and
selectively sending the response of the first server device according to the comparing step.

14. The method of claim 13, wherein the response of the first server device is sent if the response of the second server device differs from the response of the first server device.

15. The method of claim 13, wherein the response of the first server device is not sent if the response of the second server device is the same as the response of the first server device.

16. A machine readable storage, having stored thereon a computer program having a plurality of code sections executable by a portable computing device for causing the device to perform the steps of:
transmitting a service discovery message to a fixed multicast group of portable computing devices over an ad-hoc, peer-to-peer, wireless network;
receiving a service advertising message from at least one portable computing device of the fixed multicast group;
matching a service specified by the service advertising message with a location within a service registry of the portable device; and
incorporating the matched service within the service registry, wherein the matched service specifies a network address for retrieving information about the matched service.

17. The machine readable storage of claim 16, further comprising:
transmitting a query to the network address of the matched service requesting additional information about the matched service;
receiving the additional information; and
invoking the matched service.

18. A machine readable storage, having stored thereon a computer program having a plurality of code sections executable by a portable computing device for causing the device to perform the steps of:
within a first server device, receiving a service discovery message over an ad-hoc, peer-to-peer, wireless network from a client device, wherein the service discovery message requests a service;
generating a response to the service discovery message, wherein the response specifies differences between the requested service and a service registry of the first server device;
receiving a response to the service discovery message from a second server device;
comparing the response from the second server device with the response of the first server device; and
selectively sending the response of the first server device according to the comparing step.

19. The machine readable storage of claim 18, wherein the response of the first server device is sent if the response of the second server device differs from the response of the first server device.

20. The machine readable storage of claim 18, wherein the response of the first server device is not sent if the response of the second server device is the same as the response of the first server device.
